(19) United States
(12) Patent Application Publication
(10) Pub. No.: US 2007/0085774 A1
(43) Pub. Date: Apr. 19, 2007

(54) Method and apparatus for driving plasma display panel and improving display characteristics through multiple discharges

(76) Inventors: Chi-Hsiu Lin, Erlun Township (TW); Han-Yu Chao, Sinhua Township (TW)

Correspondence Address: J.C. Patents, Inc., Suite 250, 4 Venture, Irvine, CA, 92618, US

(21) Appl. No.: 11/269,923

(22) Filed: Nov. 8, 2005

(30) Foreign Application Priority Data
Oct. 19, 2005 (TW) 94136516

(51) Int. Cl. G09G 3/28

(52) U.S. Cl. 345/68

(57) ABSTRACT

A method and apparatus for driving a plasma display panel and improving the display characteristics through multi-discharge phenomenon is provided. The driving method is used for providing energy to light up at least a display unit in the plasma display panel and includes the following steps. Before providing any external energy, an energy recovery circuit provides internally stored energy so that the display unit has a first discharge through a resonance effect initiated by the internally stored energy. After the first discharge, external energy is provided to the display unit to trigger a second discharge. Thereafter, the energy recovery circuit stops providing internally stored energy to the display unit. Similarly, external energy to the display unit is also stopped. After the second discharge, the energy in the display unit is returned to the energy recovery circuit to serve as internally stored energy.

### CROSS-REFERENCE TO RELATED APPLICATION

This application claims the priority benefit of Taiwan application serial no. 94136516, filed on Oct. 19, 2005. All disclosure of the Taiwan application is incorporated herein by reference.

### BACKGROUND OF THE INVENTION

1. Field of the Invention

The present invention relates to a method and apparatus for driving a plasma display panel. More particularly, the present invention relates to a method for driving a plasma display panel and improving the display characteristics through multiple discharges.

2. Description of the Related Art

Plasma display panel (PDP) operates by producing gaseous discharge to light up a fluorescent agent. Therefore, PDP is also referred to as a gas discharge display. In general, a PDP comprises a plurality of display units as shown in FIG. 1. FIG. 1 is a schematic diagram showing a conventional plasma display panel. The plasma display panel 10 in FIG. 1 has a plurality of scan electrodes S1˜Sn, a plurality of bulk electrodes B1˜Bn and a plurality of addressing electrodes A1˜Am. The bulk electrodes B1˜Bn are also called the sustain electrodes. The scan electrodes S1˜Sn and the bulk electrodes B1˜Bn are interdigitated in parallel. The addressing electrodes A1˜Am are aligned vertically with both of the scan electrodes S1˜Sn and the bulk electrodes B1˜Bn. The addressing electrodes A1˜Am, the scan electrodes S1˜Sn and the bulk electrodes B1˜Bn are isolated from one another. The blocks intersected by the addressing electrodes A1˜Am and the scan electrodes S1˜Sn and the bulk electrodes B1˜Bn are display units (for example, the display unit 110 in FIG. 1). Each display unit is bounded by two glass panels on the top and the bottom and by the isolating panels at the front, rear, left and right sides to form a discharge space.

In the process of driving the plasma display panel 100, a resetting period, an addressing period and a sustaining period are sequentially executed in cycles. In general, the addressing period is also known as a scanning period. Each display unit can have a light-emitting state and a non-emitting state. For example, after all the display units of the PDP 100 have been reset (in the resetting period), whether the display unit 110 lights up or not has already been determined through the addressing by the addressing electrode A2 and the scan electrode Sn (in the addressing period). After the addressing period, the sustaining period immediately commences. If the display unit 110 has been set to emit light through the addressing, it continues to emit in the sustaining period. During the sustaining period, the sustaining voltage of the sustain circuit of the scan side and bulk side (not shown) is transmitted respectively by the scan electrode Sn and the bulk electrode Bn in sequence so that these two electrodes produce alternating current discharge within the discharge space of the display unit 110. The UV light generated by discharge bombard against the fluorescent material within the discharge space to produce visible light.

FIG. 2 is a timing diagram showing the relation between the voltage Vp and the brightness level in a conventional sustaining period. The voltage difference between the scan electrode Sn and the bulk electrode Bn of the display unit 110 is represented by Vp. In the conventional method for driving a plasma display panel, a single discharge is used to produce ultraviolet (UV) light. By illuminating the fluorescent material inside the discharge space with UV light, visible light is produced. In FIG. 2, the line IR indicates the brightness level of the UV light from the display unit 110 as detected by an infrared ray sensor.

Referring to FIG. 2, within the period PA, the bulk electrode Bn (or the scan electrode Sn) is connected to a ground and a ramp voltage is applied to the scan electrode Sn (or the bulk electrode Bn). At this time, the wall charges inside the display unit 110 continue to accumulate. During this period, the sum total of the energy provided and the energy of the internally accumulated wall charges is still insufficient to initiate a firing discharge. After the period PA, period PB commences. In the period PB, the total energy provided by the supplied energy and the energy of the internally accumulated wall charges exceeds the firing energy. Consequently, there is an internal discharge inside the display unit 110. In general, the discharge energy in the PB period is provided through the sustain voltage.

The period PB can be divided into a period A and a period B for better description. The period starting from the excitation of the fluorescent material by the UV rays to the production of visible light is period A and the period starting from the appearance of visible light to the end of the excitement of the fluorescent material is period B. Because a time period A and definite energy within that period is required to excite the fluorescent material before any visible light is produced, the length of the period A and the energy dosage within this period will directly affect the efficiency and brightness level produced by the fluorescent material in the subsequent period B. In other words, it is essential to minimize the energy used by the sustain voltage in period A and extend the length in period B (the period where the fluorescent material emits light) so that the display characteristics of the plasma display panel can be improved.

### SUMMARY OF THE INVENTION

Accordingly, at least one objective of the present invention is to provide a method for driving a plasma display panel (PDP) and improving the display characteristics of the PDP. Through multiple discharges, the fluorescent material inside the display unit of the PDP can have a higher light-emitting efficiency and brightness level.

To achieve these and other advantages and in accordance with the purpose of the invention, as embodied and broadly described herein, the invention provides a method for driving a plasma display panel (PDP). The method utilizes multiple discharge phenomena to improve the display characteristics of the PDP and provides energy to light up at least one display unit in the PDP. The driving method includes the following. Before providing any external energy, an energy recovery circuit provides internally stored energy so that the display unit has a first discharge through a resonance effect initiated by the internally stored energy. After the first discharge, external energy is provided to the display unit to trigger a second discharge. Thereafter, the energy recovery circuit stops providing internally stored energy to the display unit. Similarly, external energy to the display unit is also stopped. After the second discharge, the energy in the display unit is returned to the energy recovery circuit to serve as internally stored energy.

To achieve these and other advantages and in accordance with the purpose of the invention, as embodied and broadly described herein, the invention provides a appratus for driving a plasma display panel (PDP). The method utilizes multiple discharge phenomena to improve the display characteristics of the PDP and provides energy to light up at least one display unit in the PDP. The driving appratus includes an energy recovery circuit and a sustain circuit. The energy recovery circuit electrically connects to the PDP for providing internally stored energy so that the display unit has a first discharge through a resonance effect initiated by the internally stored energy. The sustain circuit electrically connects to the PDP for providing external energy to the display unit to trigger a second discharge. Wherein, after the second discharge, the energy in the display unit is returned to the energy recovery circuit to serve as internally stored energy.

In the present invention, the energy recovery circuit provides internally stored energy so that sufficient wall charges are accumulated to produce a weak discharge before the external energy (for example, the sustain voltage) generates a full discharge. In other words, the fluorescent material inside the display unit of the PDP is excited to a light-emitting state through internally stored energy. Thus, the discharge energy provided by the external energy can be completely utilized to produce light via the fluorescent material for the full discharge period. As a result, the light-emitting efficiency and brightness level of the fluorescent material inside the PDP is increased and the display characteristics of the PDP are improved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a conventional plasma display panel.

FIG. 2 is a timing diagram showing the relation between the voltage Vp and the brightness level in a conventional sustaining period.

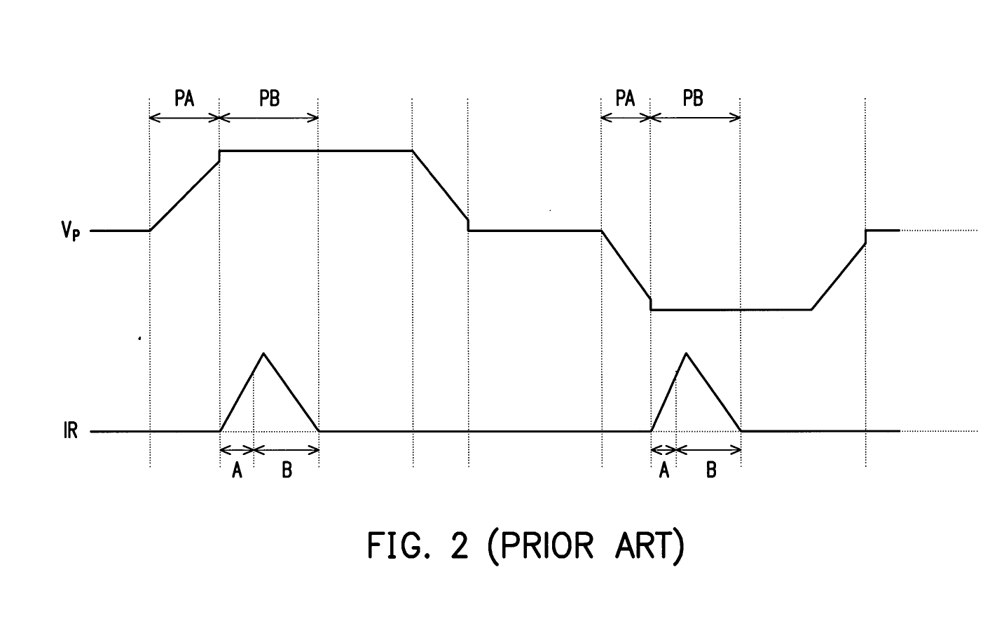

FIG. 3 is a diagram showing the scan side and bulk side driving circuit for a plasma display panel according to one embodiment of the present invention.

FIG. 4 is a timing diagram showing the timing relationship of the on-off switches, the display unit voltage and the light-emitting state for the circuit in FIG. 3 during the sustaining period.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

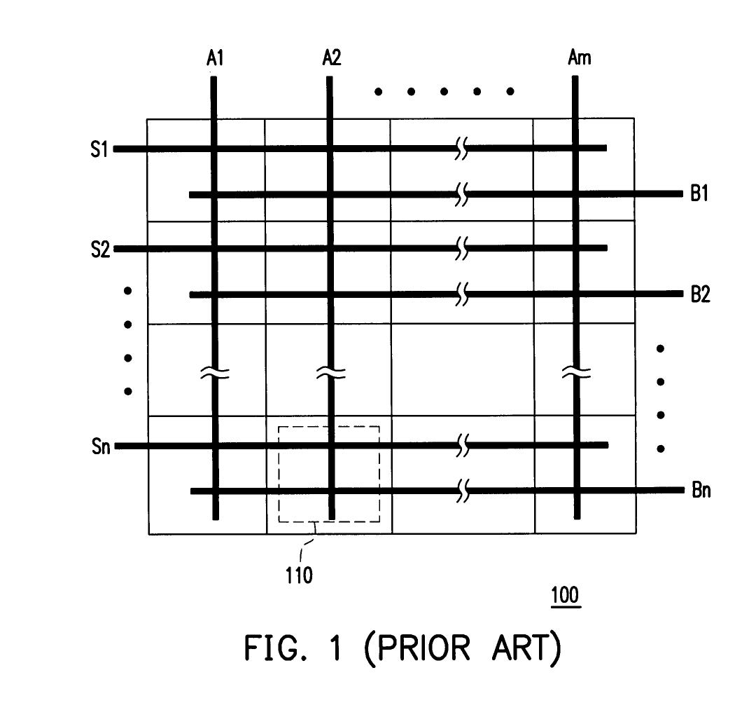

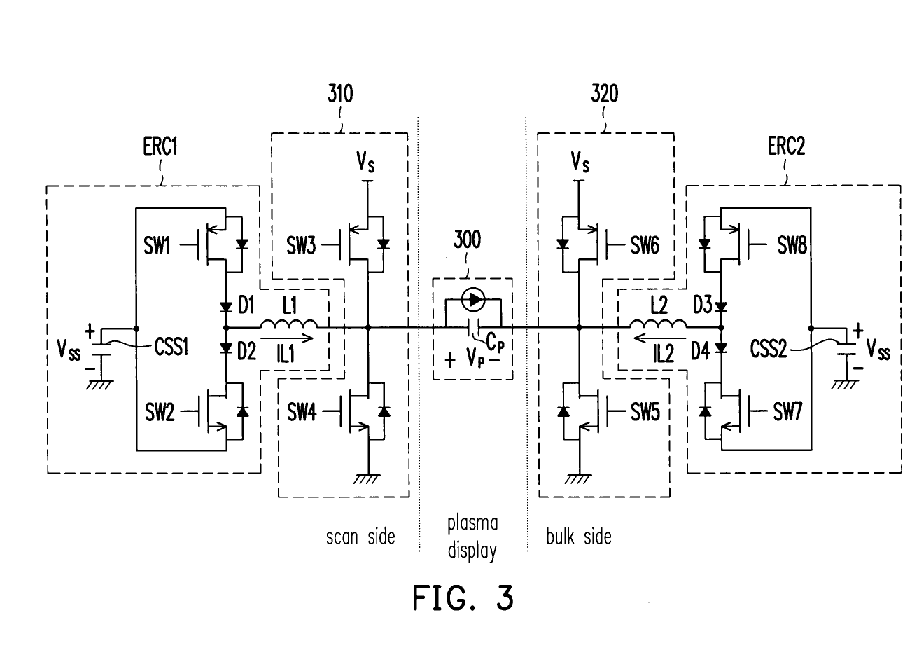

FIG. 3 is a diagram showing the scan side and bulk side driving circuit for a plasma display panel according to one embodiment of the present invention. In FIG. 3, only a display unit 300 and its associated circuits that electrically connect with a scan electrode and a bulk electrode of the display unit 300 is used to describe the display unit and related driving circuit of a PDP (for example, the PDP 100 in FIG. 1). The capacitance of the capacitor Cp is equivalent to the capacitance between the scan electrode and the bulk electrode of the display unit 300. The voltage Vp represents the voltage difference between the scan side electrode and the bulk side electrode of the display unit 300. The method of operating the circuits is explained in the following.

For example, in the sustaining period, the scan side sustain circuit 310 and the bulk side sustain circuit 320 transmit sustain voltage Vs to the two terminals of the capacitor Cp in the display unit 300 through the scan electrode and the bulk electrode alternately. Thus, the two electrodes generate an alternating discharge current in the discharge space within the display unit 300 and excite the fluorescent material to produce visible light. In general, the sustain voltage Vs is set to a high potential level (for example, between 170˜200V). To reduce the energy loss due to switching the switches SW3 and SW4 within the sustain circuit 310 (or the switches SW5 and SW6 within the sustain circuit 320), the scan side has an energy recovery circuit ERC1 and the bulk side has another energy recovery circuit ERC2.

The energy recovery circuit ERC1, for example, comprises a capacitor CSS1, a first switch SW1, a second switch SW3, a first diode D1, a second diode D2 and an inductor L1. The capacitor CSS1 is used for storing internally stored energy. A first terminal of the switches SW1 and SW2 are electrically connected to the capacitor CSS1. In the period when the internally stored energy is provided, the switch SW1 channels the internally stored energy to a second terminal of the switch SW1. In the period when the internally stored energy is returned, the switch SW2 channels the energy of the display unit 300 from a second terminal of the switch SW2 to the first terminal of the switch SW2. The anode of the diode D1 is electrically connected to the second terminal of the switch SW1 and the cathode of the diode D1 is electrically connected to the second terminal of the switch SW2. A first terminal of the inductor L1 is electrically connected to the cathode of the diode D1 and a second terminal of the inductor L1 is electrically connected to the display unit 300.

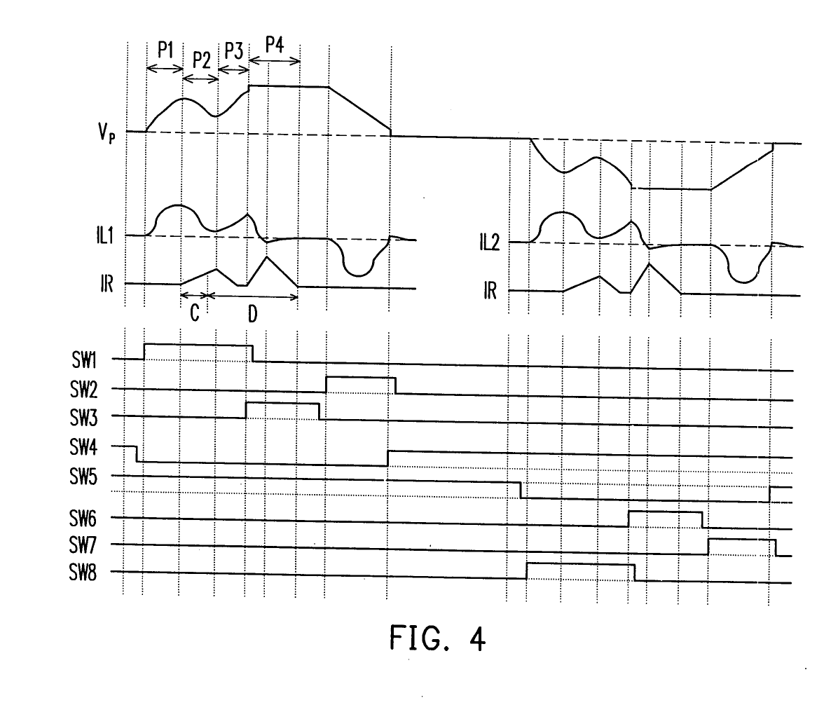

FIG. 4 is a timing diagram showing the timing relationship of the on-off switches SW1˜SW8, the display unit voltage and the light-emitting state for the circuit in FIG. 3 during the sustaining period. In FIG. 4, IR represents the state of the ultraviolet (UV) light emitted by the display unit 300 and detected by an infrared ray sensor. In the positive discharging period of the sustaining period, the switches SW6˜SW8 are maintained in an off state while the switch SW5 is maintained in a conductive state. The switch SW4 is cut off before the switch SW3 is turned on (before providing external energy). Then, the switch SW1 is turned on (start entering into P1 region in FIG. 4). At this moment, the energy recovery circuit ERC1 transmits the internally stored energy inside the capacitor CSS1 via the switch SW1, the diode D1 and the inductor L1 to the display unit 300. Utilizing the resonance effect between the capacitor Cp and the inductor L1, the released internally stored energy is able to increase the display unit voltage Vp in a resonance manner. Thus, the energy loss in the switching process due to a large voltage difference when the switch SW3 starts to turn on will be minimized. After the switch SW3 is turned on, that is, the switch SW3 starts to provide external energy (for example, provides a sustain voltage Vs), the switch SW1 can be immediately turned off. When the switch SW3 is turned off, the switch SW2 is made to turn on. Hence, the energy within the capacitor Cp can be returned to the capacitor CSS1 via the inductor L1, the diode D2 and the switch SW2 to serve as internally stored energy. Therefore, the terminal voltage Vss of the capacitor CSS1 in the energy recovery circuit ERC1 can be returned to the original potential level (for example, half of the sustain voltage Vs). Through the resonance effect between the capacitor Cp and the inductor L1, the display unit voltage Vp is decreased in a resonance manner. As a result, the energy loss in the switching process due to a large voltage drop when the switch SW4 being turned on is minimized. Meanwhile, the switch SW2 can be turned off once the switch SW4 is turned on.

In the negative discharging period of the sustaining period, the switches SW1˜SW3 are maintained in a cut-off state while the switch SW4 is maintained in a conductive state. The switch SW5 is cut-off before the switch SW6 is turned on (before providing external energy). Thereafter, the switch SW8 is turned on. At this moment, the energy recovery circuit ERC2 transmits the internally stored energy inside the capacitor CSS2 via the switch SW8, the diode D3 and the inductor L2 to the display unit 300. Utilizing the resonance effect between the capacitor Cp and the inductor L2, the released internally stored energy is able to increase the display unit voltage Vp in a resonance manner. Thus, the energy loss in the switching process due to a large voltage difference when the switch SW6 starts to turn on will be minimized. After the switch SW6 is turned on, that is, the switch SW6 starts to provide external energy (for example, provides a sustain voltage Vs), the switch SW8 can be immediately turned off. When the switch SW6 is turned off, the switch SW7 is made to turn on. Hence, the energy within the capacitor Cp can be returned to the capacitor CSS2 via the inductor L2, the diode D4 and the switch SW7 to serve as internally stored energy. Therefore, the terminal voltage Vss of the capacitor CSS2 in the energy recovery circuit ERC2 can be returned to the original potential level (for example, half of the sustain voltage Vs). Through the resonance effect between the capacitor Cp and the inductor L2, the display unit voltage Vp is decreased in a resonance manner. As a result, the energy loss in the switching process due to a large voltage drop when the switch SW5 conducts is minimized. Meanwhile, the switch SW7 can be turned off once the switch SW5 is turned on.

In the following, the positive discharge period of the sustaining period is used as an example. The multi-discharge phenomenon is divided into four time regions P1˜P4 and explained individually. In the first time period P1, the energy recovery circuit ERC1 provides internally stored energy. During this period, the voltage level in resonance with the energy recovery circuit and the wall charge voltage inside the display unit 300 continues to accumulate. Because the sum of the voltage level of the energy recovery circuit and the wall charges inside the display unit 300 together still have not reached the firing voltage, no discharge occurs in the display unit 300 yet.

When the sum of the resonance voltage level of the energy recovery circuit and the wall charge voltage inside the display unit 300 is greater than the firing voltage, the time period P2 begins. In the second time period P2, the energy recovery circuit ERC1 continues to provide internally stored energy. At this time, the internally stored energy produces a first discharge (a weak discharge) in the display unit 300 through the resonance of the serially connected capacitor Cp and the inductor L1. The UV light produced by the weak discharge starts to excite the fluorescent substance inside the display unit 300. The labeled period C in FIG. 4 indicates the period when the fluorescent substance is excited by the UV light until the visible light is produced. The labeled period D indicates the duration from the start of the emission of visible light from the fluorescent substance to the end of the excitation. In the period P2, the display unit 300 starts to produce visible light at the end of the period C. Due to the current-limiting function of the inductor L1, both the voltage Vp and the current IL1 drop. Because of the weak discharge and the wall discharge inside the display unit 300, the sum of the resonance voltage level of the energy recovery unit and the wall charge voltage is lower than the firing voltage. Consequently, the period P2 ends and the period P3 begins.

In the time period P3, the voltage Vp and the wall charge voltage of the display unit continues to accumulate. Because the period P3 is rather short in the present embodiment, the discharge condition will not be satisfied. As soon as the switch SW starts to turn on, the period P3 ends and the period P4 begins.

In the time period P4, external energy (for example, the sustain voltage Vs) is transmitted to the display unit 300. Because the illumination of the fluorescent material increases slowly and non-linearly, the intensity of the illumination in the second discharge resulted from the application of the external energy is based on the previous illumination level of the fluorescent substance. Therefore, the period D when the fluorescent material generates visible light can be extended from the second period P2 to the period P4. In addition, because the period C has already ended before providing the external energy, the external energy supplied in the period P4 can be completely used for exciting the fluorescent material to produce light. Hence, the light-emitting efficiency and brightness of the fluorescent material is significantly increased.

In the following, an experimental comparison between the conventional single discharge driving technique and the multiple discharge driving technique according to the present invention is provided. The infrared signals IR obtained through an infrared sensor are used for the comparison. Table 1 shows the data obtained from an electrical experiment on the same type of plasma display panel modules.

TABLE 1
A comparison of experimentally determined electrical data
between identical plasma display panel modules driven by
conventional single discharge technique and the multiple
discharge driving technique according to the present
invention (Vs = 175 V, Vxg = 175 V, Vw = 60 V).

| Power apc: | Full white pattern | Full black pattern |
|---|---|---|
| 205 W (for 46 AVC) | Power consumption | Power consumption |
| Single discharge | 253 W | 80 W |
| Multiple discharges | 197 W | 65.3 W |

According to Table 1, no matter whether the pattern is full white or full black, there is a dramatic drop in the power consumption in the present invention. In addition, Table 2 shows a comparison of experimentally determined optical data between identical plasma display panel modules.

TABLE 2
A comparison of experimentally determined optical data between identical
plasma display panel modules driven by conventional single discharge
technique and the multiple discharge driving technique according to the
present invention (Vs = 175 V, Vxg = 175 V, Vw = 60 V).

| Power | | | | |
|---|---|---|---|---|
| apc: | | Light- | | |
| 205 W (46 | Full white | emitting | IR signal area | IR signal area |
| AVC) | illumination | efficiency | (Scan side) | (Bulk side) |
| Single | 127.11 cd/m2 | 0.904 | 8.47 n volt-sec | 7.9 n volt-sec |
| discharge | | | | |
| Multiple | 143.56 cd/m2 | 1.31 | 9.65 n volt-sec | 9.55 n volt-sec |
| discharges | | | | |

According to Table 2, the optical characteristics in the present invention are much better than the ones provided through the conventional technique. Furthermore, the measured IR signaling area with multiple discharges is also higher than one with single discharge. All in all, the light-emitting efficiency and the brightness level of the multiple discharge driving method is better than the conventional single discharge driving technique.

In summary, the conventional single discharge driving technique utilizes a sustain voltage to provide the energy needed for exciting the fluorescent material during the excitation period and the light-emitting period; and moreover, the excitation period and the light-emitting period are completed in a single discharge. Hence, overall light-emitting efficiency and brightness level is poor. In the present invention, the energy recovery circuit provides weak discharge energy to complete the excitation period and the light-emitting period of the fluorescent material before the discharge of the sustain voltage. Therefore, there is no need for the subsequent sustain voltage to enter into an excitation period so that the fluorescent material can emit visible light in no time. As a result, the present invention can improve the display characteristics of the plasma display panel and increase the light-emitting efficiency and brightness level of the panel.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving method for providing energy to light up at least a display unit of a plasma display panel and improving the display characteristics of the plasma display panel through multiple discharges, the driving method comprising the steps of:
providing internally stored energy through an energy recovery circuit so that the internally stored energy triggers a first discharge in the display unit through a resonance effect;
providing external energy to trigger a second discharge in the display unit;
stopping the energy recovery circuit from providing internally stored energy;
cutting the supply of external energy to the display unit; and
returning the energy in the display unit to the energy recovery circuit as internally stored energy after the second discharge.

2. The driving method of claim 1, wherein the external energy is provided through a sustain voltage.

3. The driving method of claim 1, wherein the resonance is produced by the resonance function produced in a serially connected inductor-capacitor system.

4. The driving method of claim 1, wherein the energy recovery circuit comprises:
a capacitor for holding internally stored energy;
a first switch having a first terminal electrically connected to the capacitor for channeling the internally stored energy to a second terminal of the first switch in a period when the internally stored energy needs to be provided;
a second switch having a first terminal electrically connected to the capacitor for transferring the energy of the display unit from a second terminal to a first terminal of the second switch in a period when the internally stored energy is returned;
a first diode having an anode electrically connected to the second terminal of the first switch;
a second diode having an anode electrically connected to the cathode of the first diode, wherein the cathode of the second diode is electrically connected to the second terminal of the second switch; and
an inductor having a first terminal electrically connected to the cathode of the first diode, wherein the second terminal of the inductor is electrically connected to the display unit.

5. The driving method of claim 1, wherein the first discharge includes a weak discharge.

6. The driving method of claim 1, wherein providing external energy to trigger the second discharge in the display unit after the first discharge.

7. A driving apparatus for providing energy to light up at least a display unit of a plasma display panel and improving the display characteristics of the plasma display panel through multiple discharges, the driving apparatus comprising:
an energy recovery circuit electrically connected to the plasma display panel for providing internally stored energy so that the internally stored energy triggers a first discharge in the display unit through a resonance effect; and
a sustain circuit electrically connected to the plasma display panel for providing external energy to trigger a second discharge in the display unit;
wherein returning the energy in the display unit to the energy recovery circuit as internally stored energy after the second discharge.

8. The driving apparatus of claim 7, wherein the external energy is provided through a sustain voltage.

9. The driving apparatus of claim 7, wherein the resonance is produced by the resonance function produced in a serially connected inductor-capacitor system.

10. The driving apparatus of claim 7, wherein the energy recovery circuit comprises:
a capacitor for holding internally stored energy;
a first switch having a first terminal electrically connected to the capacitor for channeling the internally stored energy to a second terminal of the first switch in a period when the internally stored energy needs to be provided;
a second switch having a first terminal electrically connected to the capacitor for transferring the energy of the display unit from a second terminal to a first terminal of the second switch in a period when the internally stored energy is returned;
a first diode having an anode electrically connected to the second terminal of the first switch;
a second diode having an anode electrically connected to the cathode of the first diode, wherein the cathode of the second diode is electrically connected to the second terminal of the second switch; and
an inductor having a first terminal electrically connected to the cathode of the first diode, wherein the second terminal of the inductor is electrically connected to the display unit.

11. The driving apparatus of claim 7, wherein the first discharge includes a weak discharge.

12. The driving apparatus of claim 7, wherein providing external energy to trigger the second discharge in the display unit after the first discharge.
